(19) United States
(12) Patent Application Publication
(10) Pub. No.: US 2026/0274709 A1
(43) Pub. Date: Sep. 17, 2026

(54) Filtering System for a Storm Water Catch Basin

(71) Applicant: Trash Guard, Incorporated, Roseboro, NC (US)

(72) Inventor: Houston Linwood Crumpler, Roseboro, NC (US)

(21) Appl. No.: 19/081,194

(22) Filed: Mar. 17, 2025

(51) Int. Cl. C02F 1/00; B01D 39/08; C02F 3/10; C02F 101/10; C02F 101/16; C02F 101/20; C02F 103/00

(52) U.S. Cl. CPC C02F 1/001; B01D 39/083; C02F 3/104; C02F 3/106; C02F 2101/105; C02F 2101/16; C02F 2101/203; C02F 2101/206; C02F 2103/001

(57) ABSTRACT

A filter system for screening, filtering and treating storm water is designed to be employed within a storm water catch basin. Forming a part of the filter system is a rigid filter panel with an array of openings and designed to be mounted adjacent the outlet of the catch basin. Further, the filter system includes a permeable sock containing filter media that is designed to be disposed adjacent the bottom of the catch basin and generally below an upper portion of the rigid filter panel. Hence, the rigid filter panel and the filter media within the permeable sock screened filter the storm water passing into and through the catch basin.

### FIELD OF THE INVENTION

The present invention relates to filter systems and more particularly to filter systems designed to be employed within storm water catch basins.

### BACKGROUND OF THE INVENTION

Storm water catch basins are widely used by cities, towns and municipalities to collect storm water runoff and direct the storm water into sewer networks. But with the storm water comes all kinds of debris, like leaves, twigs, and litter that can clog catch basins, obstructing the flow of storm water. This can lead to localized flooding, damaging property and infrastructure. Besides that, storm water runoff often carries nutrients, like ammonia, nitrites, nitrates and phosphorus from fertilizers, pet waste and other sources. These nutrients can contribute to excessive algae growth in receiving waters, which leads to oxygen depletion and harming aquatic life. Furthermore, sediment carried by storm water can settle in water ways which tends to harm aquatic life and degrades overall water quality.

It is known to provide filtering structures in catch basins. See, for example, U.S. Patent 7,276,156 (the ‘156 patent). The catch basin filter shown and described in the ‘156 patent has been tested in many locations. It affords an opportunity to catch and manage stormwater solids effectively. It has proven to be effective in capturing debris and preventing debris from leaving catch basins and entering into sewer pipes. On an annual basis, the filter described in the ‘156 patent typically removes from 1,000 to 2,000 pounds of debris from a single catch basin.

Even though filter systems have been employed in catch basins, many designs fail to address water quality and the need to effectively perform at least some measure of nutrient removal at catch basin sites. As noted above, storm water runoff often includes significant concentrations of ammonia, nitrites, nitrates, phosphorus, organic matter, and various small suspended solids. Actual removal of these nutrients is beneficial at the catch basin sites. Doing so will reduce nutrient and organic matter load on downstream municipal wastewater systems and in other cases will provide some measure of nutrient removal for storm water effluents that are discharged downstream without sophisticated municipal treatment.

Therefore, there is a need for a more robust filter system for use in catch basins. In particular, there is a need to provide a catch basin filter system that is reasonably effective in nutrient removal, as well as effective in removing various forms of suspended solids that are typically not addressed by conventional filter systems employed in catch basins.

### SUMMARY OF THE INVENTION

The present invention entails a storm water catch basin filtering system that comprises a dual filtering system having on the one hand a rigid filter panel with an array of openings and on the other hand a permeable sock containing filter media, such as plastic pieces, ground corn cobs, ground corn shucks, coir filter media, or other material suitable for functioning as a filter.

When used in a catch basin, the rigid filter panel is stationed adjacent the outlet of the catch basin, requiring all or substantially all of the storm water entering the catch basin to pass through the rigid filter panel prior to reaching the outlet. Furthermore, the permeable sock containing the media can be disposed adjacent the bottom of the rigid filter panel such that storm water flowing across the bottom or the lower portion of the catch basin is constrained to pass through the permeable sock and the media therein prior to reaching the outlet of the catch basin.

Moreover, in one embodiment, the filtering system of the present invention is designed to biologically remove nutrients from the storm water passing through the catch basin. This is achieved by growing biomass or a biofilm on the media contained in the permeable sock. As the storm water passes into and through the permeable sock, the biofilm on the media contacts the storm water and through a biological process removes ammonia, nitrites, nitrates, phosphorus and even organic matter.

In addition, the present invention provides a system and process for removing metals from storm water. Biofilm supported on the media contained in the permeable sock biologically removes metals from the storm water passing therethrough by biosorption, bioaccumulation, and other mechanisms. Several metals can be biologically removed from the storm water, primarily heavy metals that impose environmental and health risks. The most common metals removed using biological treatment include lead, cadmium, mercury, nickel, copper, zinc, iron, and manganese.

The filtering system discussed below initially functions as a screening device as solids and debris enter the storm drain basin. However, as storm water solids accumulate in the basin, the filtering system converts to a filter, trapping and treating storm water solids. Further, by incorporating the permeable sock including filter media, the rigid filter panel and the permeable sock are effectively a filtering device or structure as the combined rigid panel and permeable sock facilitate the accumulation of storm water solids that enter the basin with the “first flush” of storm water. Placement of the permeable sock at the base of the rigid filter panel permits the passage of storm water through the sock while retaining the storm water solids upstream of the sock. Once storm water solids begin to accumulate, the filtering system of the present invention filters the storm water and in the filtration process, treats the storm water. As noted above, the employment of the permeable sock that contains filter media results in the solids being retained, affording numerous exchange sizes where phosphorus can be adsorbed onto solids. In areas where regulated metals are a concern, the mass of solids retained upstream of the filtration device provides exposure to organic matter that will tend to bind regulated metals and prevent their entry into the outlet of the storm water basin.

### DESCRIPTION OF THE DRAWINGS

FIG. 1 is a front elevational view of the filtering system of the present invention which comprises a rigid screening or filtering panel and a pliable sock that includes filter media.

FIG. 2 is a fragmentary elevational view showing the filtering system of the present invention secured within a storm water basin.

FIG. 3 is a sectional view from the side showing how the filter system of the present invention is installed in a storm water basin.

FIG. 4 is a front elevational view of an alternate design particularly illustrating a manner of integrating the permeable sock with the rigid screening or filtering panel.

FIG. 5 is a side elevational view of the filtering system shown in FIG. 4.

FIG. 6 is an alternative design for the filtering system of the present invention.

### DESCRIPTION OF EXEMPLARY EMBODIMENTS

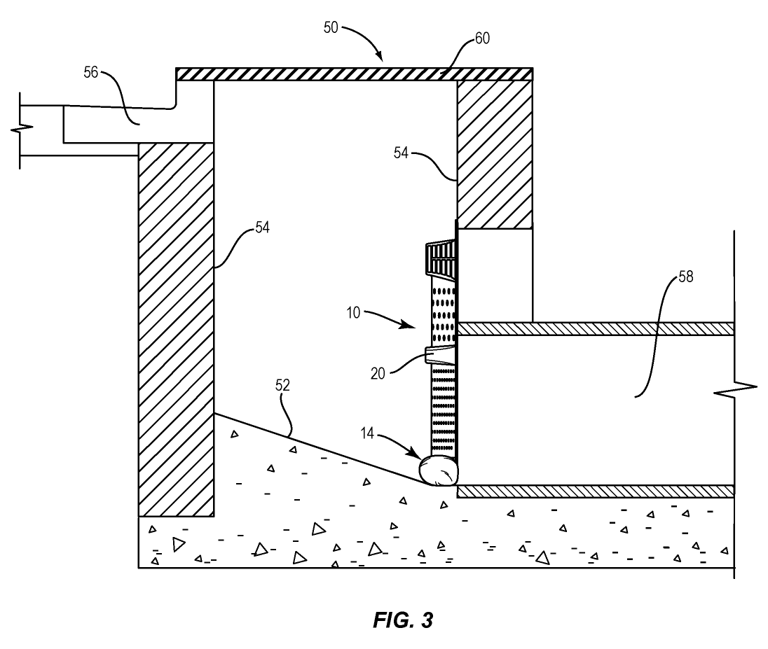

With further reference to the drawings, the catch basin filter system of the present invention is shown therein and indicated generally by the numeral 10. As is discussed in detail below, the filter system 10 is designed (configured) to be placed in a catch basin or storm drain (see FIG. 3) and appropriately positioned to filter and treat water passing through the catch basin. Filter system 10, as described below, has two main components, a rigid screening panel (sometimes referred to as a filtering panel) indicated by the numeral 12 and a permeable sock indicated generally by the numeral 14. Both the rigid screening panel 12 and the permeable sock 14 assume positions in a catch basin that enables the storm water passing through the catch basin to be filtered.

First, the main filter or rigid filter panel 12 will be discussed. It can be constructed of molded plastic, metal or any other suitable material. In some examples, the filter panel 12 is of a single piece molded construction. In other cases, the filter panel 12 may comprise two or more sections secured together. Filter panel 12 can assume various shapes and dimensions. This is because catch basins vary in design and size and hence the filter panel 12 can be dimensioned and shaped so as to conveniently fit in a particular catch basin and to assume a position therein in the direct path of storm water passing through the catch basin so as to facilitate the filtering of the storm water. In the example shown in the drawings, the filter panel 12 is of a generally curved shape and as such it includes a concave side which ordinarily faces the outlet of the catch basin and an outer curved side that would generally face away from the outlet.

Filter panel 12 includes an array of round openings 16 formed between the top and bottom of the filter. Typically, the size of the openings 16 vary with the openings disposed about the bottom portion of the filter generally being smaller than the openings formed about the intermediate and upper portion of the filter. The smaller round openings disposed about the lower portion of the filter 12 will prevent smaller objects and solids from passing through the filter about the lower portion thereof. Formed about the top of the exemplary filter panel 12 is a series of relatively large slot openings 18. It is understood and appreciated by those skilled in the art that the size and arrangement of the openings 16 and 18 can vary depending on particular circumstances at a catch basin.

Filter panel 12 includes one or more ribs 20 that are integrally formed into the structure of the filter to provide strength and rigidity. Extending along opposite sides of the filter panel 12 is a pair of mounting flanges 22. Mounting flanges 22 are provided with fastener openings and when installed in a catch basin the flanges generally abut against a side wall or mounting structure and fasteners are extended through the mounting flanges into the side wall or mounting structure in the catch basin so as to secure and hold the filter panel in place.

The second component of the filter system 10 is a pliable and permeable sock 14 and as described in more detail later, the permeable sock is designed to hold filter media. Permeable sock 14 comprises an outer pliable side that forms a bag-like structure that includes an interior space that includes the filter media. The outer side of the sock, as noted above, is permeable and includes small openings that permit water to flow into the sock, through the sock, and out of the sock. Openings in the outer side of the sock are sized smaller than the media contained therein so as to retain the media as water is flowing through the sock. The construction of the material that forms the permeable sock 14 can vary. For example, it may include a cloth or mesh fabric such as a nylon mesh, polyester mesh, even a stainless steel mesh. Furthermore, the material that forms a part of the sock could be a natural fiber such as cotton or coir (made of coconut fibers). In any event, the overall construction of the permeable sock 14 aims to provide a highly durable permeable sock that resists wear and tear and is generally chemically resistant.

The permeable sock 14 includes media 30. Media 30 contained in the permeable sock 14 can vary. For example, the media may include plastic particles/elements, ground corn cobs, ground corn shucks, and other suitable materials and even combinations of various materials. The media could include a mixture of any of the above materials and may include other types of media mixed therein for effectively removing nutrients and organic matter. For example, the media could include activated carbon for effectively addressing organic contaminants and heavy metals, zeolite that may be useful in removing ammonium ions and heavy metals or even biochar that may be effective in moving organic pollutants.

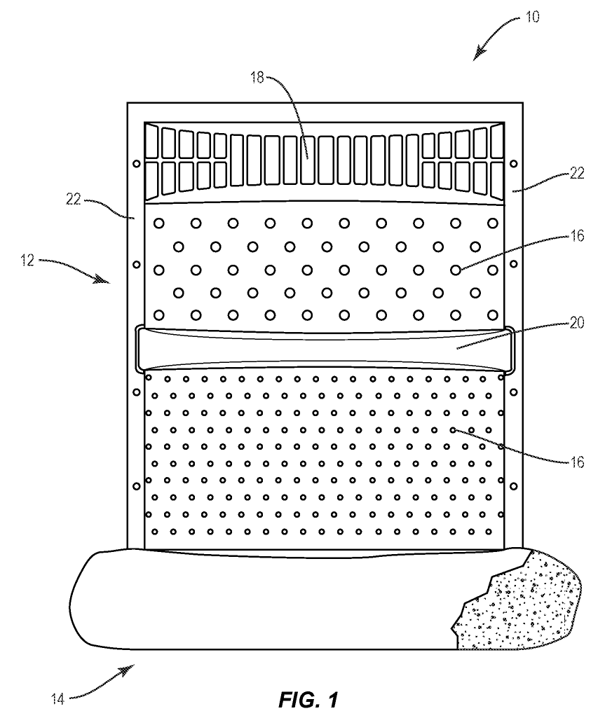

Main filter panel 12 and permeable sock 14 are generally oriented with respect to each other such that the permeable sock assumes a position adjacent the floor or bottom of the catch basin while at least a portion of the main filter panel 12 extends above the permeable sock. Permeable sock 14 can be integrated into the main filter panel 12 or attached to the filter. For example, the main filter panel 12 could be provided with an opening about the lower portion thereof, with the opening sized to receive the permeable sock 14. Permeable sock 14 could be provided with fasteners that allow it to be inserted into the opening and detachably connected to the main filter panel 12. In another embodiment, the permeable sock 14 is simply detachably connected to the lower portion of the main filter panel 12 and when employed simply lies adjacent the lower portion of the main filter panel 12 as illustrated in FIGS. 1-3. In any event, it is important that the permeable sock 14 be disposed in a position in the catch basin where the storm water is free to move through the permeable sock and into the outlet of the catch basin.

Depicted in FIG. 3 is a schematic drawing of an exemplary catch basin or storm drain that is generally indicated by the numeral 50. Catch basin 50 includes a bottom 52 and a top 60. Extending upwardly from the bottom 52 around the catch basin 50 is a side wall 54. About an upper portion of the catch basin 50 there is formed an inlet 56. Additionally, about a lower portion of the storm drain 50 there is an outlet 58 that is operative to direct storm water passing through the catch basin 50 to a piping network or sewage system. Outlet 58 can assume various forms. In the embodiment illustrated, the outlet 58 includes a pipe that extends from one side wall 54. In conventional fashion, outlet 58 channels or directs water from the catch basin 50 into a sewage pipe network.

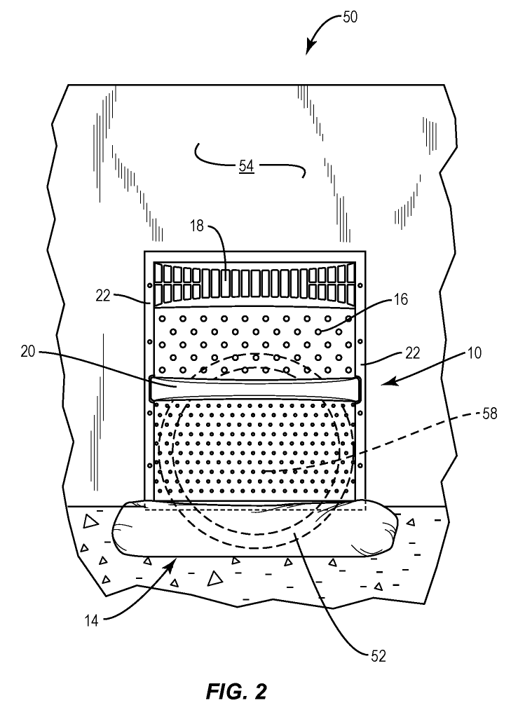

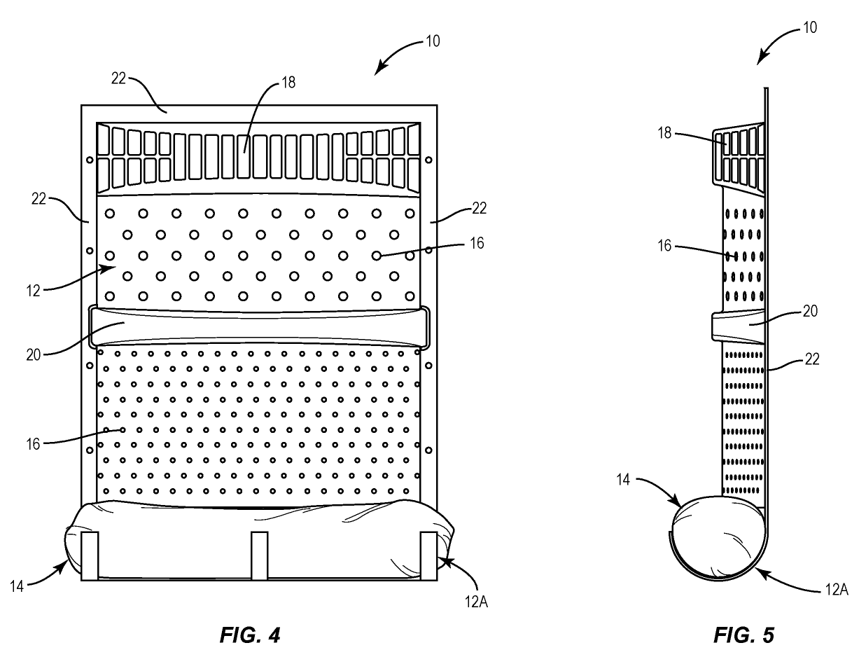

FIG. 3 illustrates how the filter system 10 of the present invention is employed in the catch basin 50. Main screening panel 12 is secured adjacent wall 54 and extends across the outlet 58. It is acknowledged that screening panel 12 functions as a basin insert and is a planned accumulation with a planned removal. Also, as explained elsewhere, the accumulated suspended solids are removed from the basin periodically. There are various ways of combining the rigid filtering panel 12 and the permeable sock 14. In the embodiment shown in FIGS. 1 and 2, the rigid panel 12 is simply placed above the permeable sock 14. Because of the weight of the permeable sock 14, it tends to remain stationary and generally fixed in the storm water basin, even though it may not be physically connected to the storm water basin or the rigid panel 12. In other embodiments, the permeable sock 14 is detachably secured to the rigid panel 12 in various ways. For example, the permeable sock 14 may be provided with fasteners that enable it to be detachably connected to the rigid panel 12. In the embodiment shown in FIGS. 4 and 5, the rigid panel 12 is provided with an extended U-shaped cradle 12A that is configured to receive and hold the permeable sock 14. Because of the pliable nature of the permeable sock 14, it conforms to the shape and slope of the bottom 52 of the catch basin 50. The interface between the screening panel 12 and outer surface of the permeable sock 14 is effectively closed. Hence, storm water passing through the lower portion of the catch basin 50 cannot circumvent the permeable sock 14. That is, the storm water passing along the bottom 52 towards the outlet 58 is constrained to move into and through the permeable sock 14. Storm water at a level above the permeable sock 14 is constrained to flow through the openings 16 in the main filter panel 12 on its way to the outlet 58.

Relatively large debris entrained with the storm water or otherwise moving into the catch basin 50 is retained on the upstream side of the filter system 10. Periodically, the accumulated debris is removed from the catch basin 50. Furthermore, the level of storm water passing through the catch basin 50 will vary from time-to-time. Generally, the water level along the bottom 52 of the catch basin 50 will be less than the height of the permeable sock 14. This means that on average and for the most part, a majority of the storm water that is received by the catch basin will pass through the permeable sock 14 and from there into the outlet 58. Permeable sock 14 functions as a filter to catch and retain suspended solids that might be as small as 0.5 microns. That is, the media in the permeable sock 14 will effectively filter and catch suspended solids.

One of the features of the filter system 10 is that when employed in a catch basin (such as shown in FIG. 3), the filter system forms a filter bed made up of suspended solids. That is, the permeable sock 14 functions to catch and trap suspended solids entrained in the storm water. These suspended solids can vary in size, but generally range from about 0.5 microns to several millimeters. Over a period of time, these suspended solids accumulate due to the presence of the permeable sock 14. That is, these suspended solids accumulate along the bottom of the catch basin upstream of the permeable sock 14. These suspended solids form a filter bed upstream of the filtering system and this filter bed functions to filter oncoming storm water and also serves to treat the water passing through the formed filter bed.

In addition, the filter media 30 can function as a biofilter. When functioning as a biofilter, a biomass or biofilm is grown on the exterior surfaces of the media 30 and this biofilm can function to biologically treat the storm water held or passing through the permeable sock 14. As discussed before, it is not uncommon for storm water to include ammonia, nitrite, nitrate, phosphorus, and organic matter. Generally speaking, aerobic conditions are maintained in and about the permeable sock 14. These aerobic conditions form a favorable environment for the growth of nitrifying bacteria that convert the ammonia (NH₄) in the storm water to nitrite which is further converted to nitrate. It is also possible for conditions in the media, at least the media that is found in the core of the permeable sock, to exist in anoxic or anaerobic conditions. This may lead to a denitrification process where the nitrate is converted to nitrogen gas. Further, if the storm water contains phosphorus, then it is possible that some portions of the media are held in anaerobic conditions which in turn are conducive to the growth of phosphorus accumulating organisms on the media that remove phosphorus from the storm water.

In any event, the media 30 contained in the permeable sock 14 can function as biocarriers. That is, the media is capable of supporting biofilm and that biofilm is capable of removing some nutrients and organic matter from the storm water passing through the permeable sock 14.

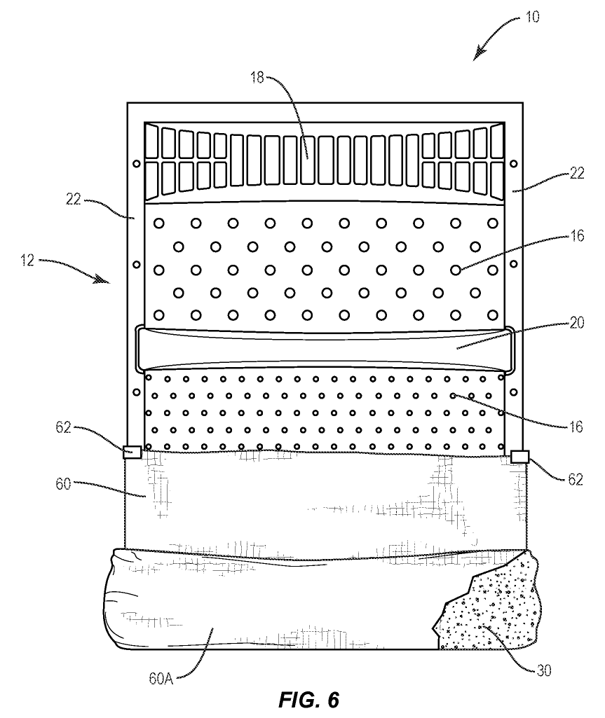

FIG. 6 shows an alternative embodiment for the filtering system of the present invention. This design includes a permeable cloth filter 60 that holds or supports the media 30. Note that the filter cloth 60 extends adjacent a lower portion of the screening panel 12 and actually covers some of the opening 16 formed in the lower portion of the screen panel. The material of the filter cloth 60 can vary. Generally, the filter cloth 60 is permeable and the openings therein are substantially smaller than the opening 16 in the screening panel 12. In one example, the filter cloth 60 takes the form of a spun bonded nylon material. See FIG. 6. The circular knitted geo-textile or spunbonded geotextile material in the example assumes a bag-like structure wherein the media 30 is contained in the bottom or the lower portion 60A of the bag-like structure. A portion of the circular knitted geo-textile or spunbonded geotextile material laps over the lower portion of the screening panel 12. Since the filter cloth 60, or in this example the circular knitted geo-textile or spunbonded geotextile material, requires exchanging from time-to-time, it is connected to the screening panel 12 by fastener clips 62 or other types of detachable fasteners. This assures that the filter cloth 60 and the media 30 supported therein remains connected or attached to the screening panel 12. Hence in this embodiment, it is seen where a portion of the storm water flows through the upper portion of the filter cloth 60 and through some of the openings 16 in the screening panel 12 and other portions of the storm water flow through the media 30 contained in the bottom portion of the filter cloth.

As described above, the system of the present invention functions in substantial part as a filter. It should be pointed out that the most effective filtering occurs below the bottom of the screening panel 12. Above this point, solids contained in the basin must be removed. That is, solids that accumulate in the basin above the level of the permeable sock 14 must be removed as a routine part of maintenance necessary to insure proper long term functioning of the system. Further, as solids are removed, they should be tested and removal rates should be recorded for various targeted constituents or pollutants that are of concern in the watershed. Testing should be based on the total maximum daily load assigned by regulatory agencies to the watershed.

There are many advantages to the catch basin filter system 10 of the present invention. First, the filter system 10 incorporates two different screening or filter types, the main filter panel 12 for filtering debris, especially large debris, and the permeable sock 14 that contains filter media for removing suspended solids and biologically treating the storm water passing through the catch basin. Not only is the filter system 10 concerned with debris, but this particular design enables the filter system 10 to address water quality and the environmental problems that result from discharging water containing ammonia, nitrite, nitrate and phosphorus into streams and lakes.

The present invention may, of course, be carried out in other specific ways than those herein set forth without departing from the scope and the essential characteristics of the invention. The present embodiments disclosed herein are therefore to be construed in all respects as illustrative and not restrictive and all changes coming within the meaning and equivalency range of the appended claims are intended to be embraced therein.

What is claimed is:

1. A storm water catch basin filtering system for removing suspended solids from storm water flowing into and through a storm water catch basin, comprising:
a. a rigid screening panel configured to be mounted in the catch basin and including an array of openings for permitting the storm water to flow through the rigid screening panel while retaining debris carried into the catch basin by the storm water;
b. a pliable and permeable filter cloth forming a lower portion of the storm water catch basin filtering system;
c. the filter cloth including a lower portion or an end portion that contains filter media; and
d. wherein the filter cloth and the media contained therein are configured to permit storm water entering the filter cloth to flow through both the filter cloth and the filter media where the filter cloth and the filter media are configured to remove suspended solids from the storm water.

2. The filtering system of claim 1 including detachable fasteners for securing the filter cloth to the rigid screening panel.

3. The filtering system of claim 1 wherein the filter media includes ground corn cobs or ground corn shucks.

4. The filtering system of claim 3 wherein the ground corn cobs or ground corn shucks form particles and wherein the particles form biocarriers that support biofilms.

5. The filtering system of claim 1 wherein the filter cloth forms a permeable sock containing the filter media, and wherein the permeable sock is disposed about a lower portion of the filtering system.

6. The filtering system of claim 1 wherein the pliable and permeable filter cloth assumes a bag and wherein the media is contained in a lower portion of the bag.

7. The filtering system of claim 6 wherein a portion of the filter cloth extends adjacent a lower portion of the screening panel and covers a group of said openings in the screening panel such that a portion of the storm water is filtered by flowing through the portion of the filter cloth extending adjacent the lower portion of the screening panel and another portion of the storm water is filtered by flowing through the media contained in the lower portion of said bag; and wherein the filtering system includes one or more detachable fasteners for securing the filter cloth to the screening panel.

8. The filtering system of claim 7 wherein the filter cloth is made of a circular knitted geo-textile or spunbonded geotextile material.

9. A method of filtering and biologically treating storm water passing through a catch basin by employing a rigid screening panel having an array of openings formed therein and a pliable and permeable sock containing biocarriers where the rigid screening panel and permeable sock are contained in the catch basin, the method comprising:
a. directing the storm water containing nutrients and debris into the catch basin;
b. directing the storm water through the catch basin and as the storm water moves through the catch basin, screening the storm water as the storm water passes through the array of openings in the rigid screening panel and in the process retaining at least some of the debris that is directed into the catch basin;
c. growing biofilm on the biocarriers contained in the permeable sock;
d. directing at least some of the storm water containing the nutrients into and through the permeable sock which is disposed in the catch basin below an upper portion of the rigid screening panel;
e. as the storm water passes through the permeable sock, contacting the storm water with biofilm supported on the biocarriers in the permeable sock; and
f. as the storm water passes through the permeable sock and contacts the biofilm supported on the biocarriers in the permeable sock, the method includes biologically removing nutrients from the storm water passing through the permeable sock.

10. The method of claim 9 wherein the storm water contains ammonia and wherein the ammonia in the storm water is biologically converted to nitrite and/or nitrate due to the biofilm on the biocarriers contacting the storm water passing through the permeable sock.

11. The method of claim 9 wherein the storm water contains phosphorus and wherein at least some of the phosphorus is removed from the storm water passing through the permeable sock by phosphorus accumulating organisms that form at least a part of the biofilm on the biocarriers in the permeable sock.

12. The method of claim 9 wherein the biocarriers are formed of ground corn cobs or ground corn shucks.

13. A method of filtering storm water passing through a catch basin by employing a filter system adjacent an outlet in the catch basin where the filter system comprises a screening panel having an array of openings and a lower oriented pliable and permeable sock containing filter media that is sized to capture suspended solids in the storm water, the method comprising:
directing the storm water containing the suspended solids into and through the pliable and permeable sock containing the filter media;
capturing the suspended solids passing through the pliable and permeable sock;
as the suspended solids are captured by the pliable and permeable sock, this results in the accumulation of suspended solids about a bottom of the catch basin upstream of the pliable and permeable sock; and
wherein the accumulation of suspended solids along the bottom of the catch basin and upstream of the pliable and permeable sock forms a suspended solids filter bed that extends over the bottom of the catch basin upstream of the permeable sock and through which some of the storm water passing through the catch basin passes, and wherein the accumulated suspended solids that form the filter bed effectively filters at least some of the storm water passing through the catch basin.

14. The method of claim 9 further including biologically removing metals from the storm water passing through the permeable sock.

15. The method of claim 14 wherein the biofilm on the biocarriers remove metals from the storm water by biosorption or bioaccumulation.
